(19) United States
(12) Patent Application Publication
(10) Pub. No.: US 2013/0228236 A1
(43) Pub. Date: Sep. 5, 2013

(54) SURFACE FLOW ENHANCEMENT DEVICE HAVING A GRIPPING PAD

(71) Applicant: Robert B EVANS, Santa Barbara, CA (US)

(72) Inventor: Robert B EVANS, Santa Barbara, CA (US)

(21) Appl. No.: 13/864,776

(22) Filed: Apr. 17, 2013

Related U.S. Application Data
(63) Continuation-in-part of application No. 13/083,505, filed on Apr. 8, 2011.

(51) Int. Cl. B62D 35/00

(52) U.S. Cl. CPC B62D 35/00
USPC 137/351

(57) ABSTRACT

A surface flow enhancement device is provided, comprising: a first part having an aerodynamic portion and a fastening portion, the aerodynamic portion for deflecting moving air incident upon the aerodynamic portion; a second part having a first side and a flat second side, the second part including a securing element for securing the second part to the fastening portion, such that the first side faces toward the first part and the flat second side faces away from the first part, and one or more attaching elements for attaching the surface flow enhancement device to a surface of a vehicle; and a gripping pad having an adhesive side that is attached to the flat second side, and a gripping side that inhibits movement of the surface flow enhancement device in a direction parallel to the surface of the vehicle when the device is attached to the surface of the vehicle.

### CROSS-REFERENCE TO RELATED PATENT DOCUMENTS

This application is a continuation-in-part of application Ser. No. 13/083,505 filed Apr. 8, 2011, entitled “SURFACE FLOW ENHANCEMENT DEVICE AND METHOD OF USING THE SAME ON A VEHICLE,” the contents of which are incorporated by reference in their entirety.

### FIELD OF THE INVENTION

The present claimed invention relates in general to increasing fluid flow as it moves across moving vehicles. More specifically it relates to surface flow enhancement devices that can be placed upon the surfaces of vehicles to enhance the circulation of the fluid across the surface area by increasing its flow rate to reduce frictional resistance, vortices or drag, eliminating the vacuum at the trailing edge.

### BACKGROUND OF THE INVENTION

All vehicles pass through a fluid environment as they move. For example, cars and airplanes move through air, boats move through air and water, and submarines move through water. As these vehicles move through their fluid environment, the fluid (e.g., air or water) is slowed down by the frictional resistance of the surface area of the body of the vehicle. This creates a layer of turbulent fluid flow that circulates along the vehicle slower than the fluid flow that is not in contact with the surface area of the vehicle. The varying speeds of fluid layers meet behind the vehicle, or any protuberances thereon, such as mirrors, wheel wells, rudders or propellers, as the vehicle it moves through the fluid at differential rates so as to form a low pressure area, or vacuum immediately behind the vehicle, or its protuberances. The turbulent layer and vortices create a drag force, which opposes the motion of the vehicle through the fluid environment. In this way, the front, sides, top, bottom, and even rear of a vehicle can contribute to the drag that vehicle suffers while in transit through the fluid environment.

One aspect of the drag force caused by fluid resistance is that caused by trailing vortices that result from the vehicle moving through the fluid, the so-called turbulent flow. Depending upon the shape and form of the vehicle, a variety of vortices can be formed along all surfaces of the vehicle. These vortices in the fluid hold the vehicle back, increasing the energy needed to move the vehicle forward. Another aspect of the drag force caused by fluid resistance involves the frictional resistance of the fluid as it passes over the various surfaces of the vehicle.

As a result of this, the speed and efficiency of a vehicle moving through the fluid environment is limited not only by the drag forces created by turbulent flow, but also by drag forces caused by frictional fluid resistance to the surface of the vehicle, which depends on the amount of fluid traveling along and past the vehicle.

Furthermore, the amount of drag caused by these sources is directly related to the amount of fuel needed to move the vehicle. As a result, much effort is made to design aerodynamic or hydrodynamic vehicles that minimize the amount of drag on the vehicle.

Unfortunately, compromises must be made in vehicle design to accommodate other parameters than just fluid resistance. Engine design, passenger comfort, safety requirements, cargo space, and even aesthetics can mean that a vehicle's design creates many undesirable vortices as it passes through its fluid environment.

It would therefore be desirable to provide a device to control the flow of a fluid as it flows past the surface of a vehicle to retard the creation of vortices that create drag against the vehicle. It would be further desirable to make this device easily attachable or detachable so that it could be more effectively added to existing vehicles or added after market.

### SUMMARY OF THE INVENTION

A surface flow enhancement device is provided, comprising: a first part having an aerodynamic portion and a fastening portion, the aerodynamic portion being configured to deflect moving air incident upon the aerodynamic portion; a second part having a first side and a flat second side, the second part including a securing element configured to secure the second part to the fastening portion of the first part, such that the first side faces toward the first part and the flat second side faces away from the first part, and one or more attaching elements configured to attach the surface flow enhancement device to a surface of a vehicle; and a gripping pad having an adhesive side that is attached to the flat second side of the second part, and a gripping side opposite to the adhesive side that is configured to inhibit movement of the surface flow enhancement device in a direction parallel to the surface of the vehicle when the surface flow enhancement device is attached to the surface of the vehicle.

The gripping side of the gripping pad may comprise at least one of: acrylic, rubber, a thermoplastic elastomer, polyvinyl chloride, polyester, vinyl, and polyurethane.

A plurality of projections may be formed on the gripping side to be perpendicular to the of the flat second side of the second part, and a tip of each of the plurality of projections may be configured to move in a direction parallel to the flat second side of the second part when force is applied to the tip in the direction parallel to the flat second side of the second part.

The aerodynamic portion may have a teardrop shape. The teardrop shape may have a length between 1 and 5 inches, and a width between 0.5 and 2.5 inches. The aerodynamic portion may also be one of a fin shape and an oval shape with a front fin.

The one or more attaching elements may comprise one or more magnets. The one or more magnets may be rare-earth magnets.

The one or more attaching elements may be further configured to detach the surface flow enhancement device from the surface of the vehicle without altering the surface of the vehicle.

The gripping side of the gripping pad may have an adhesive surface.

A surface flow enhancement device is provided, comprising: an aerodynamic surface having a teardrop shape; one or more attaching elements configured to attach the surface flow enhancement device to a surface of a vehicle; and a gripping surface configured to inhibit movement of the surface flow enhancement device in a direction parallel to the surface of the vehicle when the surface flow enhancement device is attached to the surface of the vehicle, wherein the teardrop shape has a length between 1 and 5 inches, and wherein the teardrop shape has a width between 0.5 and 2.5 inches.

The aerodynamic surface may comprise a first material, and the gripping surface may comprise a second material softer than the first material. The second material may comprise at least one of: acrylic, rubber, a thermoplastic elastomer, polyvinyl chloride, polyester, vinyl, and polyurethane.

The gripping surface may comprise a plurality of projections attached to a common planar base, and extending perpendicular to the common planar base, the plurality of projections all being substantially the same length, and a tip of each of the plurality of projections may be configured to move in a direction parallel to the common planar surface of the gripping pad when force is applied to the tip in the direction parallel to the common planar surface.

The aerodynamic surface may define one or more concavities on an opposite side of the aerodynamic surface, and the one or more attaching elements may be formed in the one or more concavities.

The one or more attaching elements comprise one or more magnets. The one or more magnets may be rare-earth magnets.

The one or more attaching elements may be further configured to detach the surface flow enhancement device from the surface of the vehicle without altering the surface of the vehicle.

The gripping side of the gripping surface may have an adhesive surface.

### BRIEF DESCRIPTION OF THE DRAWINGS

The accompanying figures where like reference numerals refer to identical or functionally similar elements and which together with the detailed description below are incorporated in and form part of the specification, serve to further illustrate an exemplary embodiment and to explain various principles and advantages in accordance with the present invention.

FIGS. 1A to 1E are diagrams of a surface flow enhancement device according to a disclosed embodiment;

FIG. 2 is a perspective view of the surface flow enhancement device of FIGS. 1A to 1E from above;

FIG. 3 is perspective view of the surface flow enhancement device of FIGS. 1A to 1E from below;

FIG. 4 is a cross-section of the surface flow enhancement device of FIGS. 1A to 1E along line I-I from FIGS. 1D and 1E;

FIG. 5 is a perspective view of the surface flow enhancement device of FIGS. 1A to 1E from above and affixed to a surface of a vehicle;

FIG. 6 is a perspective view of multiple copies of the surface flow enhancement device of FIGS. 1A to 1E from above and affixed to a surface of a vehicle;

FIGS. 7A to 7E are diagrams of a surface flow enhancement device according to another disclosed embodiment;

FIGS. 8A to 8E are diagrams of a surface flow enhancement device according to another disclosed embodiment;

FIG. 9 is a rear view of a vehicle showing a placement of an array of the surface flow enhancement device of FIGS. 1A to 1E on a top of the vehicle, according to a disclosed embodiment;

FIG. 10 is an overhead view of a vehicle showing a placement of an array of the surface flow enhancement device of FIGS. 1A to 1E on a top of the vehicle, according to a disclosed embodiment;

FIG. 11 is a diagram showing air flow from above of a vehicle using an array of the surface flow enhancement device of FIGS. 1A to 1E, according to a disclosed embodiment;

FIG. 12 is a diagram showing air flow from the right and rear of a vehicle using an array of the surface flow enhancement device of FIGS. 1A to 1E, according to a disclosed embodiment;

FIG. 13 is a diagram showing air flow from the rear of a vehicle using an array of the surface flow enhancement device of FIGS. 1A to 1E, according to a disclosed embodiment;

FIG. 14 is a diagram showing isoturbulence from the right and rear of a vehicle using an array of the surface flow enhancement device of FIGS. 1A to 1E, according to a disclosed embodiment;

FIG. 15 is a diagram showing isoturbulence from the rear of a vehicle using an array of the surface flow enhancement device of FIGS. 1A to 1E, according to a disclosed embodiment;

FIG. 16 is an overhead view of a vehicle showing a placement of an array of surface flow enhancement devices on a top of a vehicle, according to disclosed embodiments;

FIG. 17 is an overhead view of a vehicle showing a placement of an array of surface flow enhancement devices on a top of a vehicle, according to disclosed embodiments;

FIG. 18 is an overhead view of a vehicle showing a placement of an array of surface flow enhancement devices on a side of a vehicle, according to disclosed embodiments;

FIG. 19 is an overhead view of a vehicle showing a placement of an array of surface flow enhancement devices on a front of a vehicle, according to disclosed embodiments;

FIG. 20 is a perspective view of a surface flow enhancement device 2000 with separated first part, second part, and gripping pad, according to disclosed embodiments;

FIG. 21 is a perspective view of the surface flow enhancement device of FIG. 20 with the second part attached to the first part, and the gripping pad separated from the second part, according to disclosed embodiments;

FIG. 22 is a perspective view of the surface flow enhancement device of FIG. 20 with the second part attached to the first part, and the gripping pad attached to the second part, according to disclosed embodiments;

FIG. 23 is a bottom view of the surface flow enhancement device of FIG. 22 according to disclosed embodiments;

FIG. 24 is a top view of the gripping pad of FIG. 20, according to disclosed embodiments; and

FIG. 25 is a side view of the gripping pad of FIG. 20, according to disclosed embodiments.

### DETAILED DESCRIPTION

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Surface Flow Enhancement Device

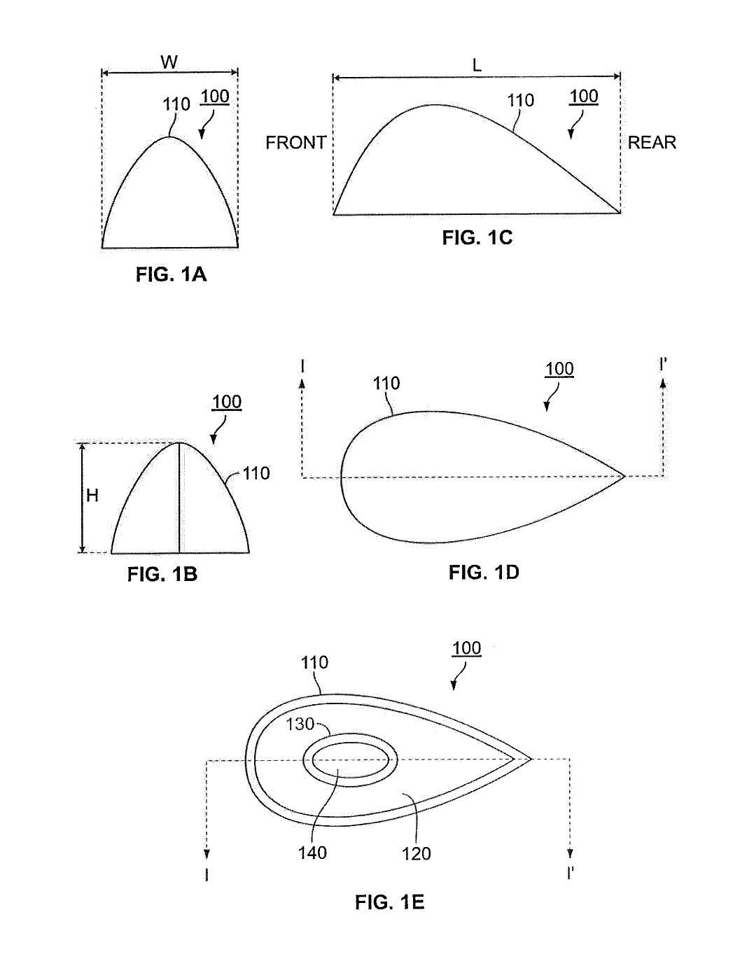

FIGS. 1A to 1E are diagrams of a surface flow enhancement device 100 according to a disclosed embodiment. FIG. 1A is a front view; FIG. 1B is a rear view; FIG. 1C is a left side view; FIG. 1D is a top view; and FIG. 1E is a bottom view.

As shown in FIGS. 1A to 1E, the surface flow enhancement device 100 has a generally half-teardrop shape, curved at a front end, pointed at a rear end, and flat on the bottom. The surface flow enhancement device 100 of this embodiment includes a main surface 110, a concavity 120, a protrusion 130, and a magnet 140.

The main surface 110 forms the half-teardrop shape with a flat bottom. This flat bottom allows it to be placed on a relatively flat surface of a vehicle and allows the main surface 110 to deflect fluid (e.g., air or water) moving past the surface of the vehicle.

In the disclosed embodiments, the length (L) of the surface flow enhancement device 100 is about 2.5 inches; the width (W) of the surface flow enhancement device 100 is about 1.2 inches; and the height (H) of the surface flow enhancement device 100 is about 1 inch. However, this is by way of example only. The length (L), width (W), and height (H) may vary depending upon the size of the body of the vehicle they are used on and the expected speed of the vehicles. For example, on a mid-sized automobile that will travel at speeds of between 40 and 80 miles per hour, the length (L) may vary between approximately 1 and 5 inches; the width (W) may vary between approximately 0.5 and 2.5 inches; and the height (H) may vary between approximately 0.5 and 2 inches.

In more general terms, the shape of the main surface should be chosen such that it is proportionally wider at the front end than at the trailing end, and that its overall surface area is approximately twice that of its footprint.

In the disclosed embodiments, the main surface 110 is made out of polyurethane. However, in alternate embodiments any similar tough, flexible material can be used. In other alternate embodiments a fixed material, such as metal or hard plastic can be used.

The concavity 120 is a hollow area formed inside of the main surface 110, and serves to make the surface flow enhancement device 100 both lighter and cheaper to manufacture. In the disclosed embodiments, it also allows the main surface to deform slightly as the surface flow enhancement device 100 is affixed to the surface of a vehicle, expelling some of the air from the concavity 120, and creating a low-pressure seal with the surface of the vehicle.

The protrusion 130 extends from the main surface 110 into the concavity 120 and forms a holder for the magnet 140. In this embodiment, the protrusion extends toward, but not quite reaching, the flat end of the main surface.

The magnet 140 is contained securely in the protrusion 130, and is provided to attach securely to the surface of the vehicle when the surface is a magnetic metal. In the disclosed embodiments, the magnet 140 is a rare-earth magnet, though alternate embodiments could use other types of magnets. In addition, although only one magnet 140 is provided in this embodiment, alternate embodiments could employ two or more magnets 140, each secured by the same or a different protrusion 130. Furthermore, although one or more magnets 140 are shown as an affixing element in the disclosed embodiments, alternate elements for affixing the surface flow enhancement device 100 to the surface of a vehicle can be employed.

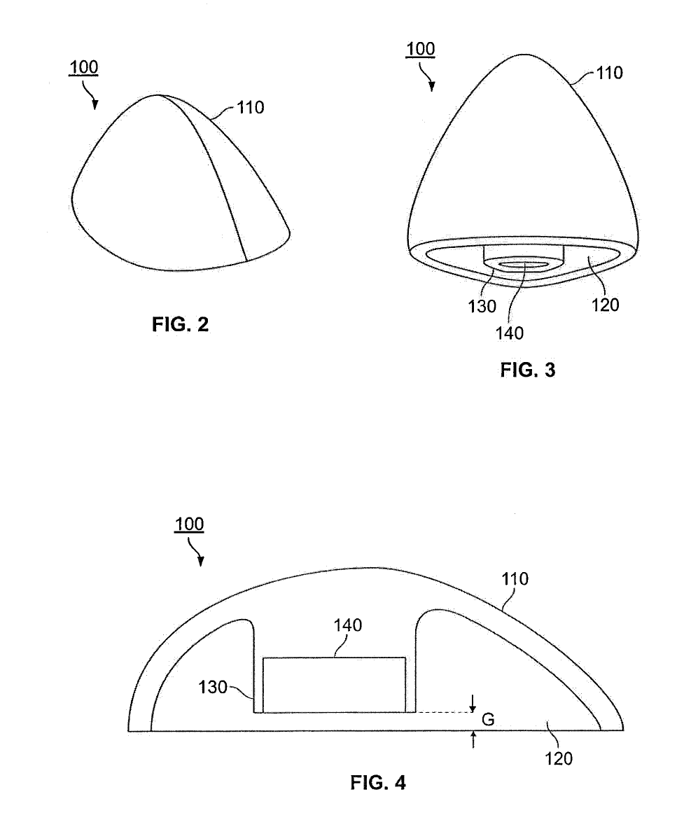

FIG. 2 is a perspective view of the surface flow enhancement device 100 of FIGS. 1A to 1E from above, while FIG. 3 is perspective view of the surface flow enhancement device 100 of FIGS. 1A to 1E from below. Taken in conjunction with FIGS. 1A to 1E, FIGS. 2 and 3 show further details of the shape of the main surface 110 of the surface flow enhancement device 100, and the arrangement of the protrusion 130 and the magnet 140 within the concavity 120 formed by the main surface 110.

FIG. 4 is a cross-section of the surface flow enhancement device 100 of FIGS. 1A to 1E along line I-I from FIGS. 1D and 1E. As shown in FIG. 4, in this embodiment, the protrusion 130 and the magnet 140 are formed within the concavity 120 such that the magnet 140 is substantially coplanar with the bottom surface of the main surface 110, but is recessed in the concavity 120 by a gap (G). Because of this, when the surface flow enhancement device 100 of FIG. 4 is placed on a magnetic metal surface of a vehicle in an above-water environment (i.e., in air, not in water), the magnet 140 will pull the main surface 110 down slightly as it makes contact with the surface of a vehicle, slightly deforming the main surface 110, and expelling air from the concavity 120. This will make the pressure in the concavity 120 slightly lower than the outside pressure, creating a low-pressure seal that will increase the holding power of the surface flow enhancement device 100 onto the surface of the vehicle, beyond that provided by the magnet alone.

In addition, by employing this structure to affix the surface flow enhancement device 100 to the surface of a vehicle, the surface flow enhancement device 100 can be made more secure during normal operation of the vehicle, but also more easily removable when desired.

As described in the embodiments above, the surface flow enhancement device 100 is affixed to the surface of a vehicle by a combination of magnetism and a low-pressure seal between the concavity 120 and the surface of the vehicle. This combination of forces can provide a very secure attachment of the surface flow enhancement device 100 to the surface of the vehicle during normal operation. This secure attachment will be sufficient to allow the surface flow enhancement device 100 to resist being moved by the force of fluid pressing against it as the vehicle moves.

However, should a user desire to remove the surface flow enhancement device 100 (e.g., to relocate it, replace it, repair it, etc.), the user can deform the main body 110 by simple pressure between two fingers. This will break the seal between the concavity 120 and the surface of the vehicle, leaving only the magnetic affixing between the magnet 140 and the surface of the vehicle. The user can then simply pull the surface flow enhancement device 100 off of the surface of the vehicle.

Fluid flowing against the surface flow enhancement device 100 during normal operation of the vehicle will not provide the pinpoint pressure that a user's fingers can, and so will not distort the main body 110 or break the seal between the concavity 120 and the surface of the vehicle. As a result, during normal operation of the vehicle, the surface flow enhancement device 100 will remain affixed to the surface of the vehicle by both magnetic force and the low-pressure seal between the concavity 120 and the surface of the vehicle, and will be able to withstand a great deal of force exerted against it by fluid passing over the surface of the vehicle.

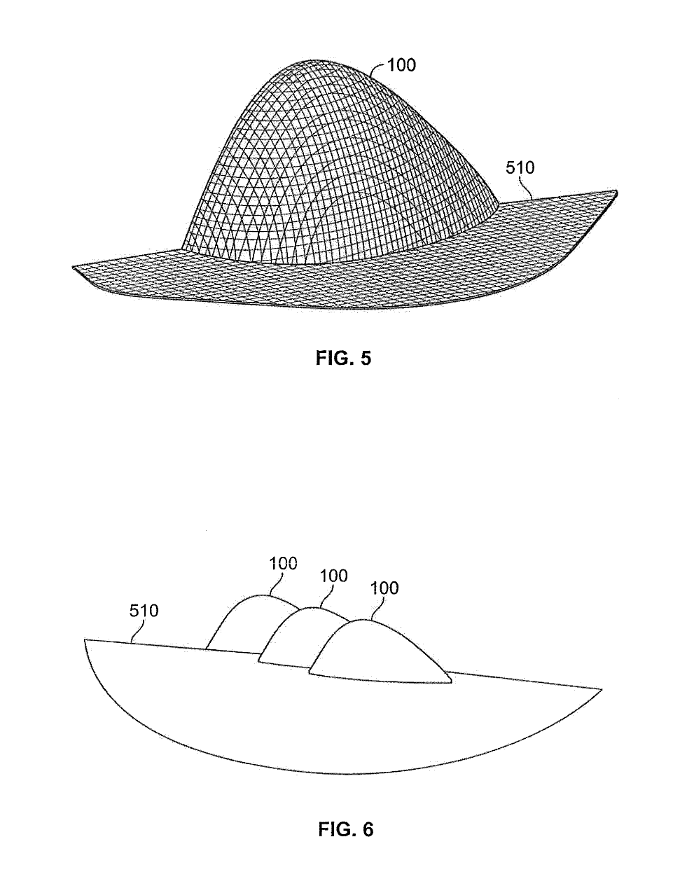

FIG. 5 is a perspective view of the surface flow enhancement device 100 of FIGS. 1A to 1E from above and affixed to a surface of a vehicle. As shown by FIG. 5, the surface flow enhancement device 100 is affixed to the surface 510 of a vehicle such that the flat side of the main surface 110 is pressed against the surface of the vehicle.

FIG. 6 is a perspective view of multiple copies of the surface flow enhancement device 100 of FIGS. 1A to 1E from above and affixed to a surface 510 of a vehicle. As shown by FIG. 6, more than one surface flow enhancement device 100 can be used in an array to increase their efficiency. FIG. 6 shows the surface flow enhancement devices 100 placed in a linear array. However, alternate embodiments could place them in any sort of regular or irregular array as desired to reduce the formation of vortices.

Alternate Surface Flow Enhancement Device Shapes

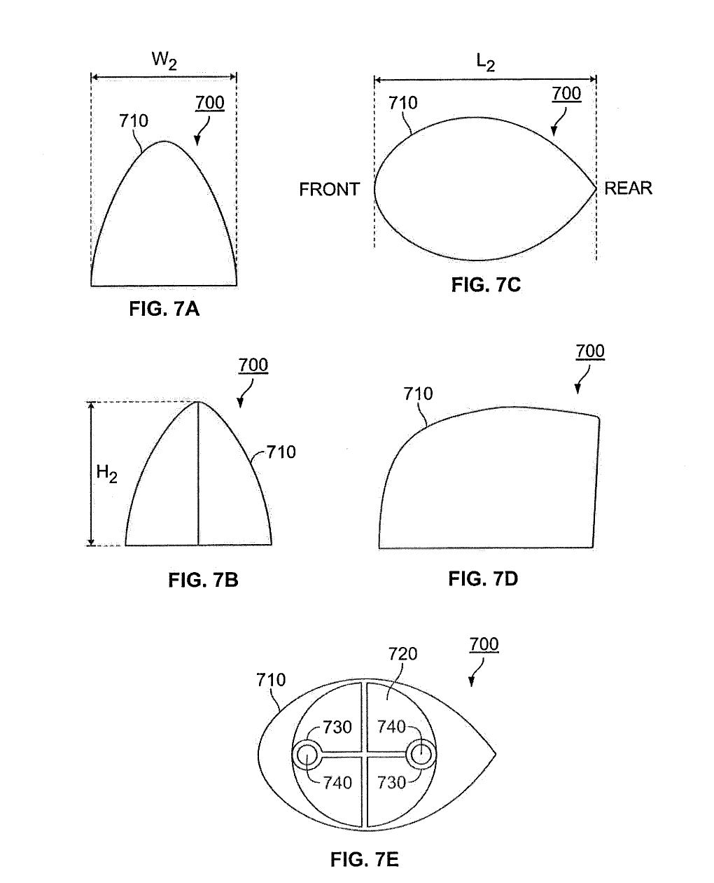

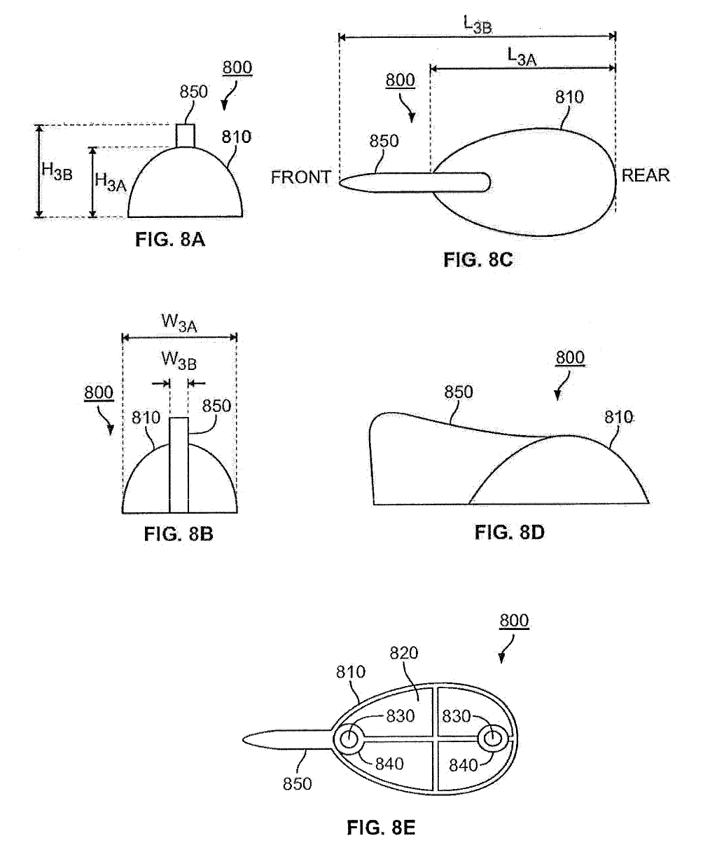

Although a single surface flow enhancement device 100 is described above, this is only by way of example. Alternate shapes can be used for the surface flow enhancement device 100 in other embodiments. FIGS. 7A to 7E and FIGS. 8A to 8E show two exemplary alternate embodiments. However other shapes can be used in alternate embodiments that serve to align circulation and retard the formation of vortices.

FIGS. 7A to 7E are diagrams of a surface flow enhancement device 700 according to another disclosed embodiment. FIG. 7A is a front view; FIG. 7B is a rear view; FIG. 7C is a left side view; FIG. 7E is a top view; and FIG. 7E is a bottom view.

As shown in FIGS. 7A to 7E, the surface flow enhancement device 700 is generally fin-shaped, with a curved front, a pointed rear, and a flat bottom. The surface flow enhancement device 700 of this embodiment includes a main surface 710, a concavity 720, a protrusion 730, and two magnets 740.

The main surface 710 forms the fin shape with a flat bottom. This flat bottom allows it to be placed on a relatively flat surface of a vehicle and allows the main surface 710 to deflect fluid (e.g., air or water) moving past the surface of the vehicle.

In the disclosed embodiments, the length (L₂) of the surface flow enhancement device 700 is about 2.5 inches; the width (W₂) of the surface flow enhancement device 700 is about 1.75 inches; and the height (H₂) of the surface flow enhancement device 100 is about 1.75 inches. However, this is by way of example only. As noted above, the length (L), width (W), and height (H) may vary depending upon the size of the body of the vehicle they are used on and the expected speed of the vehicles. For example, on a mid-sized automobile that will travel at speeds of between 40 and 80 miles per hour, the length (L) may vary between approximately 1 and 5 inches; the width (W₂) may vary between approximately 0.75 and 3.5 inches; and the height (H) may vary between approximately 0.75 and 3.5 inches.

The concavity 720 is a hollow area formed inside of the main surface 710, and serves to make the surface flow enhancement device 700 both lighter and cheaper to manufacture. In the disclosed embodiments, it also allows the main surface to deform slightly as the surface flow enhancement device 700 is affixed to the surface of a vehicle, expelling some of the air from the concavity 720, and creating a low-pressure seal with the surface of the vehicle.

The protrusion 730 extends from the main surface 710 into the concavity 720 and forms a holder for the magnets 740. In this embodiment, the protrusion extends toward, but not quite reaching, the flat end of the main surface.

The magnets 740 are contained securely in the protrusion 730, and are provided to attach securely to the surface of the vehicle when the surface is a magnetic metal. In the disclosed embodiments, the magnets 740 are rare-earth magnets, though alternate embodiments could use other types of magnets. In addition, although two magnets 740 are provided in this embodiment, alternate embodiments could employ one magnet 740 or three or more magnets 740, each secured by the same or a different protrusion 730. Furthermore, although one or more magnets 740 are shown as an affixing element in the disclosed embodiments, alternate elements for affixing the surface flow enhancement device 100 to the surface of a vehicle can be employed.

FIGS. 8A to 8E are diagrams of a surface flow enhancement device 800 according to another disclosed embodiment. FIG. 8A is a front view; FIG. 8B is a rear view; FIG. 8C is a left side view; FIG. 8D is a top view; and FIG. 8E is a bottom view.

As shown in FIGS. 8A to 8E, the surface flow enhancement device 800 is generally oval, with a front fin, and a flat bottom. The surface flow enhancement device 800 of this embodiment includes a main surface 810, a concavity 820, a protrusion 830, two magnets 840, and a fin 850.

The main surface 810 forms the oval shape and fin with a flat bottom. This flat bottom allows it to be placed on a relatively flat surface of a vehicle and allows the main surface 810 to deflect fluid (e.g., air or water) moving past the surface of the vehicle.

The concavity 820 is a hollow area formed inside of the main surface 810, and serves to make the surface flow enhancement device 800 both lighter and cheaper to manufacture. In the disclosed embodiments, it also allows the main surface to deform slightly as the surface flow enhancement device 800 is affixed to the surface of a vehicle, expelling some of the air from the concavity 820, and creating a low-pressure seal with the surface of the vehicle.

The protrusion 830 extends from the main surface 810 into the concavity 820 and forms a holder for the magnets 840. In this embodiment, the protrusion extends toward, but not quite reaching, the flat end of the main surface.

The magnets 840 are contained securely in the protrusion 830, and are provided to attach securely to the surface of the vehicle when the surface is a magnetic metal. In the disclosed embodiments, the magnets 840 are rare-earth magnets, though alternate embodiments could use other types of magnets. In addition, although two magnets 840 are provided in this embodiment, alternate embodiments could employ one magnet 840 or three or more magnets 840, each secured by the same or a different protrusion 830. Furthermore, although one or more magnets 840 are shown as an affixing element in the disclosed embodiments, alternate elements for affixing the surface flow enhancement device 100 to the surface of a vehicle can be employed.

The fin 850 is attached to the front of the main body 810 and is both thinner and higher than the main body 810.

In the disclosed embodiments, the length (L_{3B}) of the surface flow enhancement device 800 including the main body 810 and the fin 850 is about 2.5 inches, while the length (L_{3A}) of the main body 810 alone is about 1.65 inches. The width (W_{3A}) of the main body 810 is about 1 inch, while the width (W_{3B}) of the fin 850 is about 0.2 inches. The height (H_{3A}) of the main body 810 is about 0.5 inches, while the height (H_{3B}) of the fin 850 is about 0.75 inches. However, this is by way of example only. As noted above, the length (L), width (W), and height (H) may vary depending upon the size of the body of the vehicle they are used on and the expected speed of the vehicles. For example, on a mid-sized automobile that will travel at speeds of between 40 and 80 miles per hour, the length (L_{3A}) may vary between approximately 0.8 and 3 inches; the length (L_{3B}) may vary between approximately 1.25 and 5 inches; the width (W_{3A}) may vary between approximately 0.5 and 2 inches; the width (W_{3B}) may vary between approximately 0.1 and 0.4 inches; the width (H_{3A}) may vary between approximately −0.25 and 1 inches; and the height (H_{3B}) may vary between approximately 0.3 and 1.5 inches.

Placement and Operation of Surface Flow Enhancement Devices

As noted above, the surface flow enhancement devices 100, 700, 800 can be placed on the surfaces of vehicles to divert the flow of fluid (e.g., air or water) around the surface of the device and increase the circulation of the fluid around the vehicle when it is moving and prevent the friction resistance that can increase the drag that the vehicle suffers as it moves.

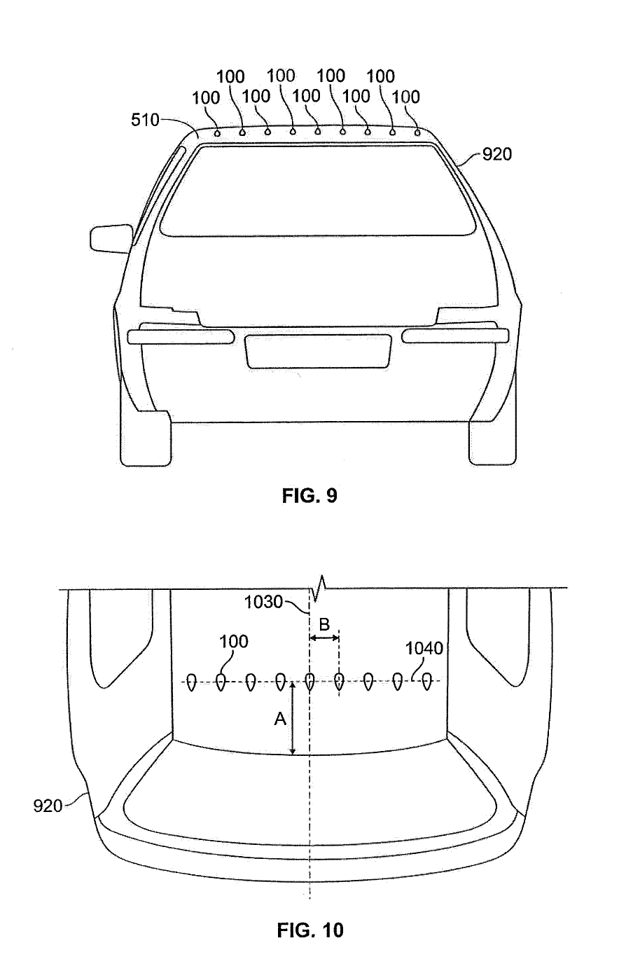

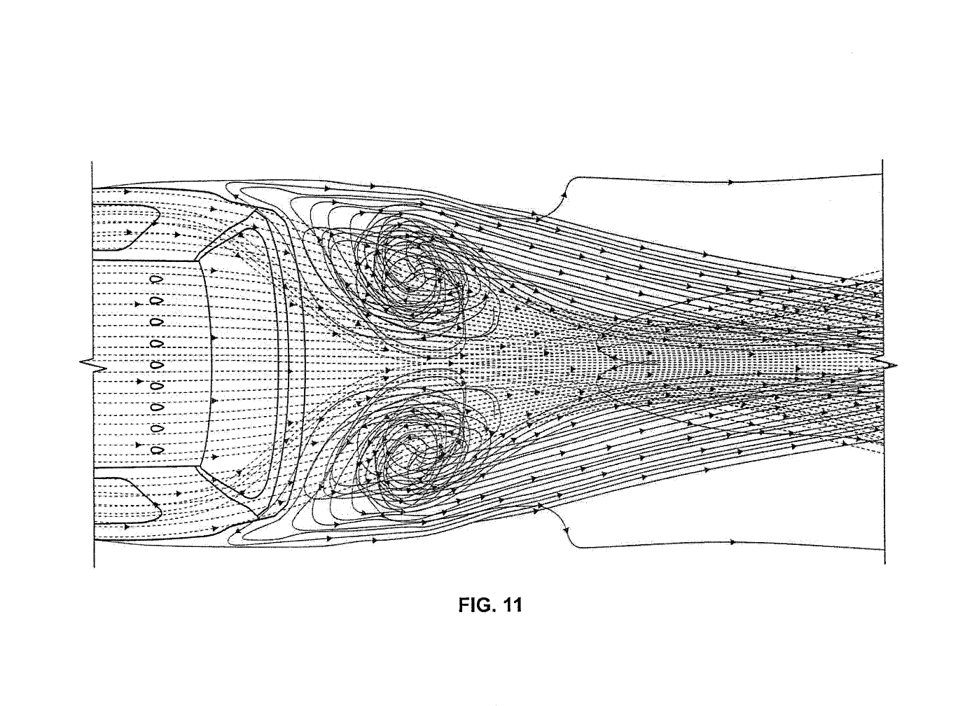

FIGS. 9 and 10 show the placement of multiple surface flow enhancement devices 100 on the roof of a car, by way of example. FIGS. 11 to 15 then show how the presence of these surface flow enhancement devices 100 influences the flow of air past the car.

FIG. 9 is a rear view of a vehicle showing a placement of an array of the surface flow enhancement device 100 of FIGS. 1A to 1E on a roof 510 of the vehicle 920, according to a disclosed embodiment, while FIG. 10 is an overhead view of a vehicle 920 showing a placement of an array of the surface flow enhancement device 100 of FIGS. 1A to 1E on a roof 510 of the vehicle 920, according to a disclosed embodiment.

As shown in FIGS. 9 and 10, multiple surface flow enhancement devices 100 are placed on the roof 510 of a vehicle 920. In this embodiment, they are placed in a line 1040 that is formed a distance A from the rear of the roof 510. One of the surface flow enhancement devices 100 is placed along a centerline 1030 of the roof 510, and the others are placed a distance B from the others along the line 1040. In this embodiment A is set to be about 7.5 inches, and B is set to be about 2.5 inches. However, this is by way of example only. In other embodiments the placement of the surface flow enhancement devices 100 can vary dramatically.

In normal operation, without the surface flow enhancement devices 100, air would flow over the roof 510 of the vehicle 920, forming vortices behind the vehicle 920 as it moved forward, and these vortices would increase the drag suffered by the vehicle 920. However, as shown in FIGS. 11 to 15, the inclusion of the surface flow enhancement devices 100 on the roof 510 of the vehicle 920 significantly reduces the formation of these vortices.

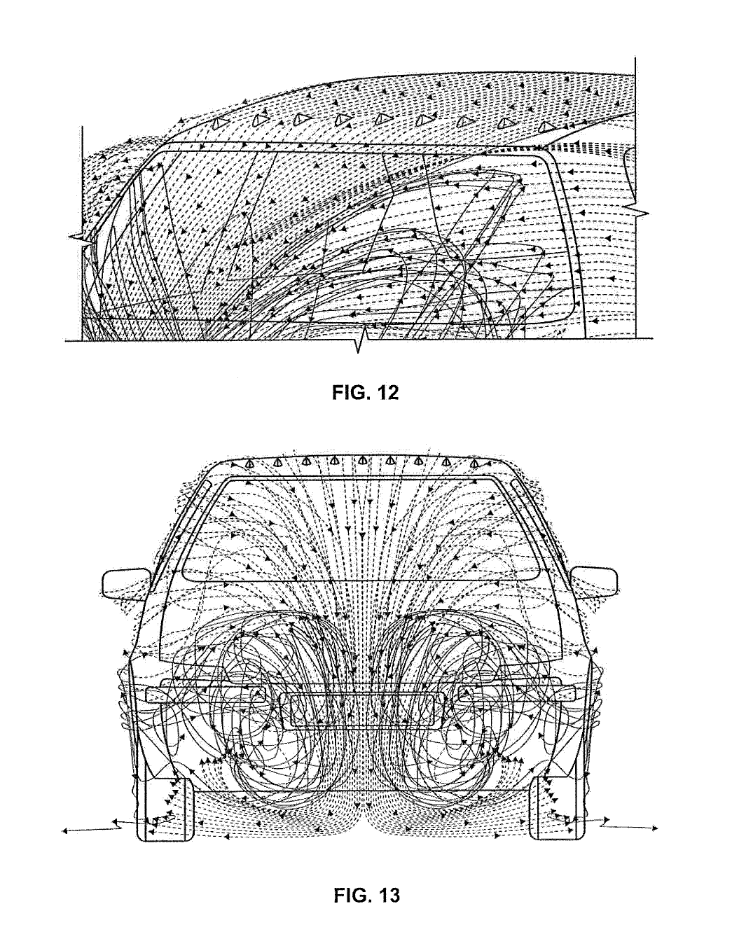

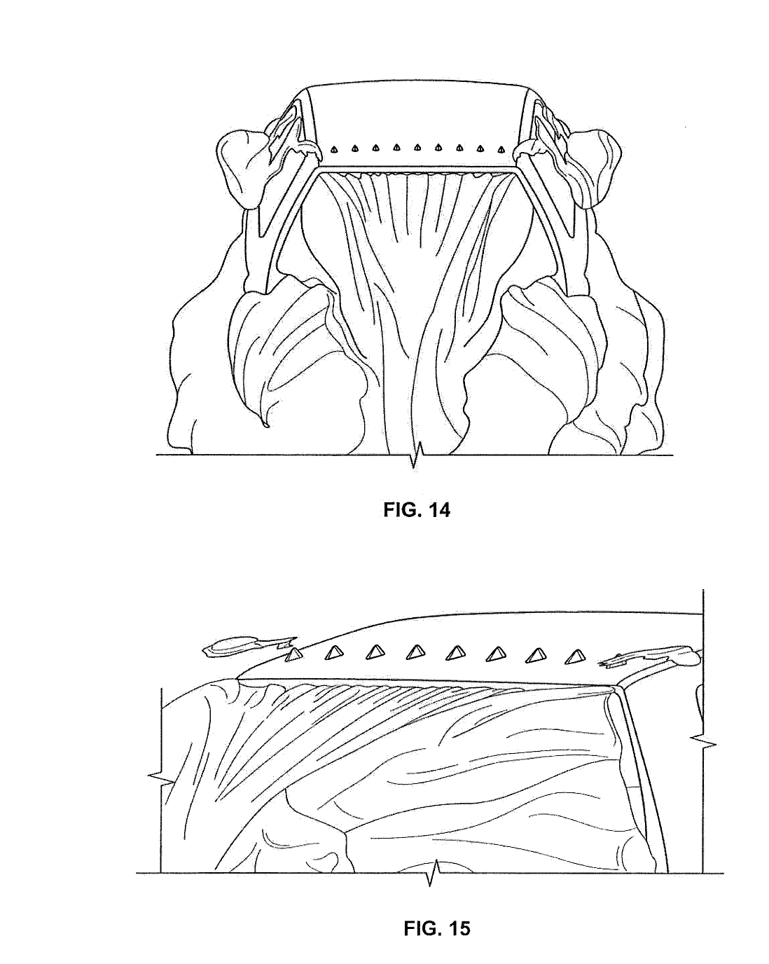

FIG. 11 is a diagram showing air flow from above of a vehicle using an array of the surface flow enhancement device of FIGS. 1A to 1E, according to a disclosed embodiment; FIG. 12 is a diagram showing air flow from the right and rear of a vehicle using an array of the surface flow enhancement device of FIGS. 1A to 1E, according to a disclosed embodiment; and FIG. 13 is a diagram showing air flow from the rear of a vehicle using an array of the surface flow enhancement device of FIGS. 1A to 1E, according to a disclosed embodiment. As shown in FIGS. 11 to 13, the surface flow enhancement devices 100 break up the flow of the air as it passes over the roof 510 of the vehicle, inhibiting the formation of vortices behind the car.

Similarly, FIG. 14 is a diagram showing isoturbulence from the right and rear of a vehicle using an array of the surface flow enhancement device of FIGS. 1A to 1E, according to a disclosed embodiment; and FIG. 15 is a diagram showing isoturbulence from the rear of a vehicle using an array of the surface flow enhancement device of FIGS. 1A to 1E, according to a disclosed embodiment. As shown in FIGS. 14 and 15, the surface flow enhancement devices 100 break up the flow of the air as it passes over the roof 510 of the vehicle, reducing the amount of isoturbulence behind the car.

As shown in FIGS. 11 to 15, the presence of the surface flow enhancement devices 100 on the roof 510 of the vehicle 920 reduces both the presence of vortices and the isoturbulence behind the vehicle 920. This reduces the drag on the vehicle 920, and so the amount of energy required to move it forward. As a result, this also increases the fuel efficiency of the vehicle 920.

Furthermore, although FIGS. 9 to 15 show an embodiment in which several surface flow enhancement devices 100 are placed on the back of a roof 510 of a vehicle 920, the placement of one or more surface flow enhancement devices 100 on other surfaces of the vehicle 920, or any other vehicle that passes through a fluid atmosphere (e.g., air or water). For example, surface flow enhancement devices 100 could be placed on the front hood, on the back hood, on the sides, or even the bottom of a car; they could be placed on the hull of a ship, they could be placed on the fuselage or wings of an airplane, etc. Any vehicle that passes through a fluid atmosphere can benefit from the attachment of one or more surface flow enhancement devices.

In addition, since surface flow enhancement devices are easily attachable and detachable, they can be added after market, and placed wherever they are needed. And should a better location be found, they can be easily moved to new locations. In fact, it would be possible for users without access to sophisticated sensors to simply place one or more surface flow enhancement devices on their vehicle and measure whether gas mileage decreases. The user can then adjust the number and placement of the surface flow enhancement devices as desired until a most efficient configuration is determined

The user can also adjust the shape of surface flow enhancement devices used, if multiple shapes are available. For example, if one shape is particularly effective on one part of a vehicle, and another shape is more effective on another part of the vehicle, the user can mix and match as needed. And if an improved surface flow enhancement device shape becomes available, the user can replace the surface flow enhancement devices 100 as desired.

The easy attachment and detachment of the surface flow enhancement devices also allows for easy maintenance, cleaning, replacement, and removal. The user need not fear that the surface flow enhancement devices 100 will detract from the value of the vehicle, nor inhibit a resale, nor that they will wear out and be difficult or expensive to replace.

Alternate Placement of Surface Flow Enhancement Devices

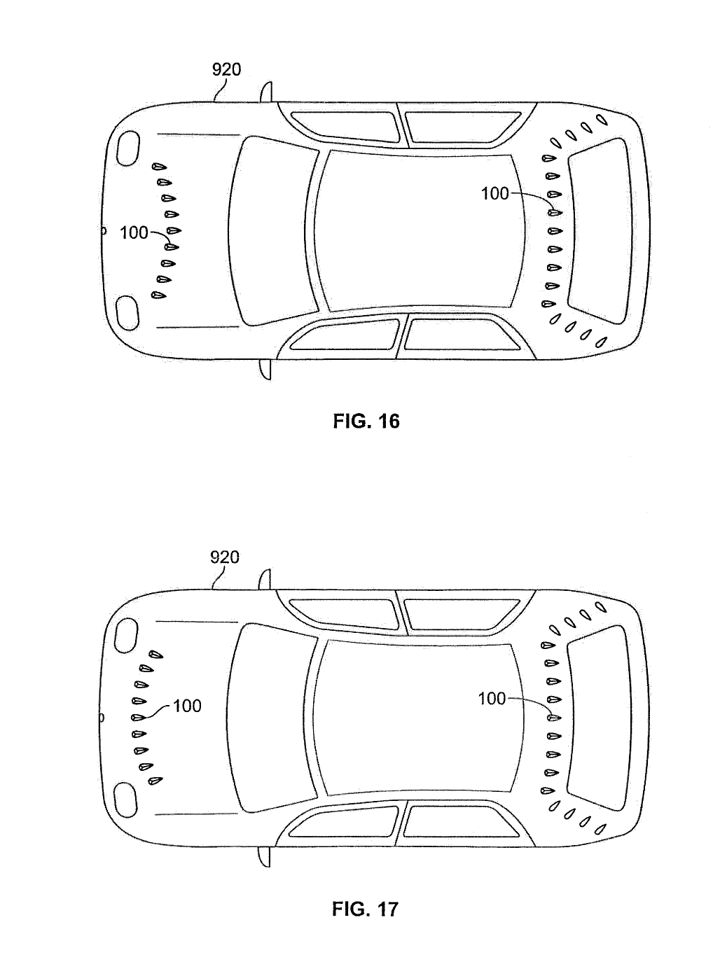

As noted above, many alternate placement positions are possible for surface flow enhancement devices. FIGS. 16 to 19 disclose several possible alternate placement schemes for an automobile embodiment.

FIG. 16 is an overhead view of a vehicle showing a placement of an array of surface flow enhancement devices on a top of a vehicle, according to disclosed embodiments. As shown in FIG. 16, surface flow enhancement devices 100 can be placed on the front hood of a vehicle 920 in an arc curving away from the front of the vehicle 920. They can also be placed in a line on the rear roof and sides of the vehicle 920.

FIG. 17 is an overhead view of a vehicle showing a placement of an array of surface flow enhancement devices on a top of a vehicle, according to disclosed embodiments. As shown in FIG. 17, surface flow enhancement devices 100 can be placed on the front hood of a vehicle 920 in an arc curving toward the front of the vehicle 920. They can also be placed in a line on the rear roof and sides of the vehicle 920.

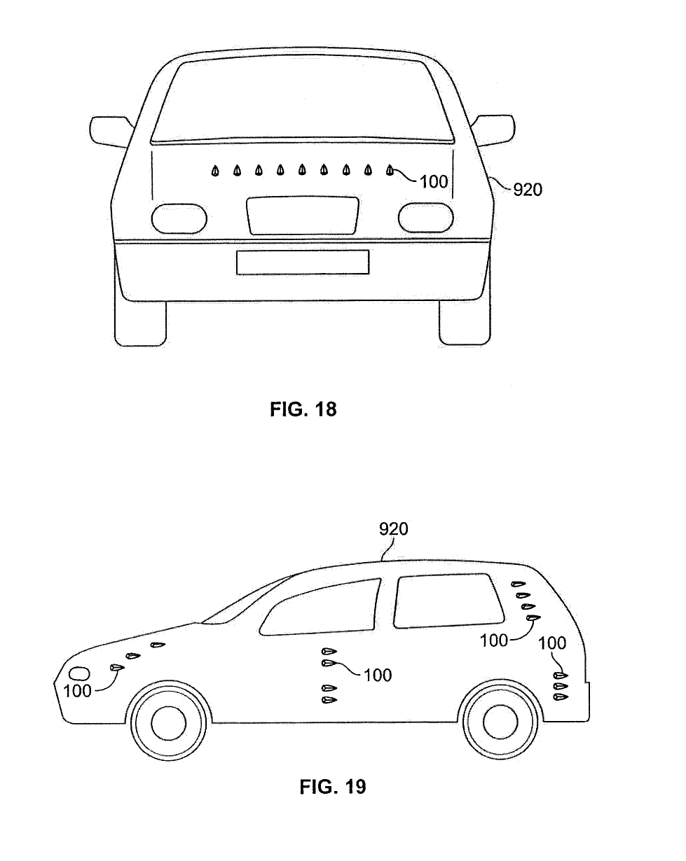

FIG. 18 is an overhead view of a vehicle showing a placement of an array of surface flow enhancement devices on a side of a vehicle, according to disclosed embodiments. As shown in FIG. 18, surface flow enhancement devices 100 can be placed on the front hood of a vehicle 920 in a line.

FIG. 19 is an overhead view of a vehicle showing a placement of an array of surface flow enhancement devices on a front of a vehicle, according to disclosed embodiments. As shown in FIG. 19, surface flow enhancement devices 100 can be placed in a line on the side of the of a vehicle 920, in a line on a door of the vehicle 920, or in a line on the rear side of the vehicle 920.

Various combinations of these and other arrangements can also be made. In addition, although the embodiments above all show an automobile by way of example, surface flow enhancement devices can be used on any vehicle that passes through a fluid environment. For example, they can be used on automobiles, trucks, motorcycles, airplanes, space planes, helicopters, missiles, drones, ships, boats, and submarines.

Inclusion of a Gripping Pad

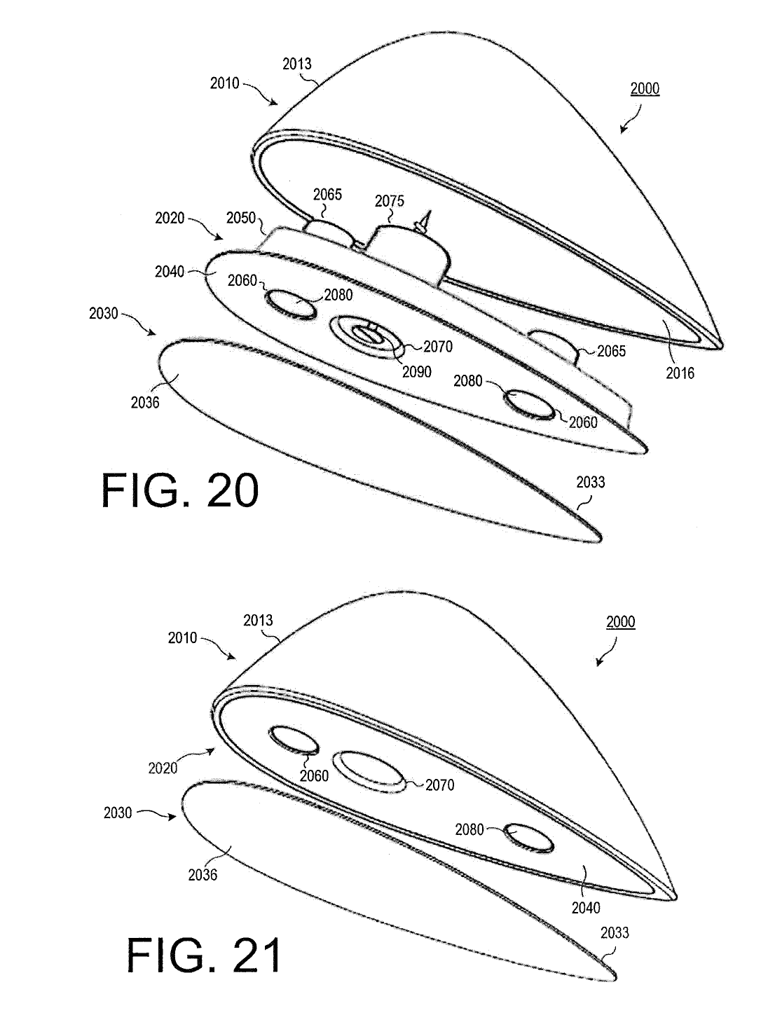

FIG. 20 is a perspective view of a surface flow enhancement device 2000 with separated first part 2010, second part 2020, and gripping pad 2030, according to disclosed embodiments. As shown in FIG. 20, the surface flow enhancement device 2000 of this embodiment (when fully assembled) has a generally half-teardrop shape, curved at a front end, pointed at a rear end, and flat on the bottom, similar to the embodiment shown in FIGS 1A to 1E. The surface flow enhancement device 2000 of this embodiment includes a first part (a main surface) 2010, a second part 2020 (a bottom surface), and a gripping pad 2030.

In the disclosed embodiments, the first and second parts 2010 and 2020 are made out of hard plastic. However, in alternate embodiments any similar tough, flexible material can be used. In other alternate embodiments a fixed material, such as metal or polyurethane can be used.

The first part 2010 has an aerodynamic portion 2013 and a fastening portion 2016, the aerodynamic portion 2013 being configured to deflect moving air incident upon the aerodynamic portion 2013. In this disclosed embodiment, the aerodynamic portion 2013 forms a convexity, while the fastening portion 2016 forms the concavity on the opposite side of the convexity. Having the fastening portion 2016 be a concavity formed inside the convexity of the aerodynamic portion 2013 serves to make the surface flow enhancement device 2000 both lighter and cheaper to manufacture.

The second part 2020 has a first side 2040 and a second side 2050. The first side 2040 has a flat surface and one or more recesses 2060, 2070 formed in it. The second side 2050 has a series of protrusions 2065, 2075 poking out of it. These protrusions 2065, 2075 correspond to the recesses 2060, 2070 on the first side 2040.

One or more first recesses 2060 each contain a magnet 2080 that operates as an attaching element to attach the surface flow enhancement device 2002 a metal surface (e.g., a surface of a vehicle) in a manner in which it can be detached without altering the surface of the vehicle. These magnets 2080 are secured in the first recesses 2060 by swaging the magnets 2080 into first recesses 2060. Glue can also be used as a primary or secondary securing mechanism.

A second recess 2070 contains a securing element 2090 that operates to secure the second part 2020 to the first part 2010. In the disclosed embodiment, the securing element 2090 is a screw or a bolt, the shaft of which passes through a hole in the bottom of the recess 2070/top of the protrusion 2075 and secures to a screw hole (not shown) in the fastening portion 2016 of the first part 2010.

In alternate embodiments however, different securing mechanisms can be used. For example, in one alternate embodiment, the securing element 2090 could be a clipping mechanism on the protrusion 2075 that clips into a recess in the fastening portion 2016 of the first part 2010. Any other suitable securing mechanism could be used in alternate embodiments.

The second part 2020 is configured to fit together with the first part 2010 to entirely close off the fastening portion 2016. When the first and second parts 2010, 2020 are fit together, the securing mechanism 2090 is used to secure these two parts 2010, 2020 together.

The gripping pad 2030 has an adhesive side 2033 and a gripping side 2036. The adhesive side 2033 of the gripping pad 2030 is formed using an adhesive strong enough to adhere the gripping pad 2030 to the second part 2020 such that lateral force applied to the first part 2010 will not cause the second part 2020 to separate from the gripping pad 2030. Any suitable adhesive can be used to form the adhesive side 2033. In one embodiment, a 3M™ GM614 pressure-sensitive adhesive-backed gripping material is used for the gripping pad, in which the adhesive is an acrylic pressure-sensitive adhesive. However, many other adhesives can be used.

The gripping side 2036 of the gripping pad 2030 forms a gripping surface that is pressed up against a surface of a vehicle when the magnets 2080 (i.e., the attaching elements) attach the surface flow enhancement device 2000 to the surface of the vehicle. The gripping side 2036 is made of a material that operates to inhibit movement of the surface flow enhancement device 2000 in a direction parallel to the surface of the vehicle when the surface flow enhancement device 2000 is attached to the surface of the vehicle by the magnets 2080, and pressure (e.g., moving air) is pushed against the aerodynamic portion 2013 of the upper part 2010 of the surface flow enhancement device 2000.

The gripping side 2036 can be made of any material that has a coefficient of friction with respect to the various metals that are used in the manufacture of vehicles sufficient to inhibit movement of the surface flow enhancement device in a direction parallel to the surface of the vehicle when the surface flow enhancement device 2000 is attached to the surface of the vehicle by the magnets 2080. In some embodiments the coefficient of friction may be 0.5 or greater. In other embodiments, the coefficient of friction may be 1.0 or greater.

In some embodiments, the gripping side 2036 is a flat material. In other embodiments, the gripping side 2036 is formed of a plurality of projections attached to a common planar base and extending perpendicular to the common planar base. These projections are each the same length, and serve to increase the friction between the gripping side 2036 and the surface of the vehicle. In operation, the tip of each of the plurality of projections will move in the direction parallel to the common planar surface (i.e. parallel to the surface of the vehicle) when force is applied to the tip in a direction parallel to the common planar surface.

In some embodiments, the gripping side 2036 can be made of an adhesive material that permanently or temporarily affixes the surface flow enhancement device 2000 to the surface of the vehicle, preventing lateral movement of the surface flow enhancement device 2000.

Any suitable material can be used to form the gripping side 2036. However, in various embodiments, acrylic, rubber, a thermoplastic elastomer, polyvinyl chloride, polyester, vinyl, and polyurethane can be used as the gripping material. In one embodiment, a 3M™ GM614 pressure-sensitive adhesive-backed gripping material is used for the gripping pad, in which the gripping material is a thermoplastic elastomer. In another embodiment the gripping side is made of a permanent acrylic adhesive material such as is used in a 3M™ VHB™ tape. However, many other gripping surfaces can be used for the gripping side 2036.

The gripping pad 2030 has a shape similar to that of the flat surface of the first side 2040 of the second part 2020, when the adhesive side 2033 of the gripping pad 2030 is facing the flat surface of the first side 2040 of the second part 2020. In this way, the adhesive side 2033 of the gripping pad 2030 can be secured to the flat surface of the first side 2040 of the second part 2020, effectively providing the gripping side 2036 of the gripping pad 2030 as a new surface of the first side 2040 of the second part 2020. This gripping side 2036 of the gripping pad 2030 serves as a bottom surface of the surface flow enhancement device 2000.

FIG. 21 is a perspective view of the surface flow enhancement device 2000 of FIG. 20 with the second part 2020 attached to the first part 2010, and the gripping pad 2030 separated from the second part 2020, according to disclosed embodiments.

As shown in FIG. 21, the second part 2020 is fitted into the concavity in the first part 2010 defined by the fastening portion 2016 of the first part 2010. Once it is fit together with the first part 2010, the second part 2020 is secured to the first part 2010 by the securing element 2090. The securing element 2090 is not shown in the embodiment of FIG. 21 because it is too deep in the recess 2070 to be seen.

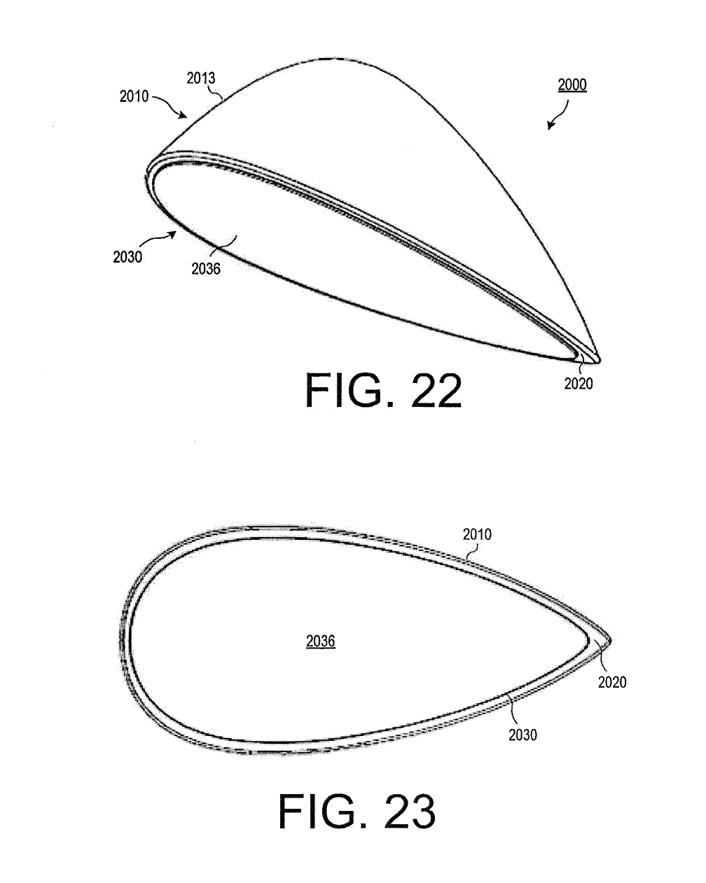

FIG. 22 is a perspective view of the surface flow enhancement device 2000 of FIG. 20 with the second part 2020 attached to the first part 2010, and the gripping pad 2030 attached to the second part 2020, according to disclosed embodiments.

As shown in FIG. 22, when the gripping pad 2030 is attached to the combined first and second parts 2010, 2020, it forms a bottom surface of the surface flow enhancement device 2000. In this way, the gripping pad 2030 obscures the recesses 2060, 2070, and the magnets 2080 and securing element 2090 contained within the recesses 2060, 2070.

Because the gripping pad 2030 is secured to the combined first and second parts 2010, 2020 by an adhesive, it will be very difficult to separate the gripping pad 2030 from the combined first and second parts 2010, 2020. As a result, the coefficient of friction between the gripping side 2036 of the gripping pad and the surface of the vehicle, combined with the force with which the magnets 2080 press the surface flow enhancement device 2000 against the vehicle, will determine whether or not the surface flow enhancement device 2000 will move in a direction parallel to the surface of the vehicle when pressure is applied to the surface flow enhancement device 2000 in a direction parallel to the surface of the vehicle (e.g., by the flow of air against the aerodynamic surface 2013 of the first part 2010).

FIG. 23 is a bottom view of the surface flow enhancement device 2000 of FIG. 22 according to disclosed embodiments. As shown in FIG. 23, the gripping pad 2030 is substantially the same shape as the bottom of the combined first and second parts 2010, 2020, and is attached to the bottom of the combined first and second parts 2010, 2020.

In the disclosed embodiment, the gripping pad 2030 is actually a little smaller then the bottom of the combined first and second parts 2010, 2020, although the exact size of the gripping pad 2030 can vary in alternate embodiments. In particular, the size of the gripping pad 2030 can be either large or smaller than the bottom of the first and second parts 2010, 2020, or could even be the same size as the bottom of the combined first and second parts 2010, 2020.

Furthermore, there is no specific requirement that the gripping pad 2030 be of the same shape as the bottom of the combined first and second parts 2010, 2020. However, doing so minimizes the amount of gripping material needed to obtain maximum friction between the gripping pad and the surface of the vehicle, while maintaining an aesthetically pleasing design.

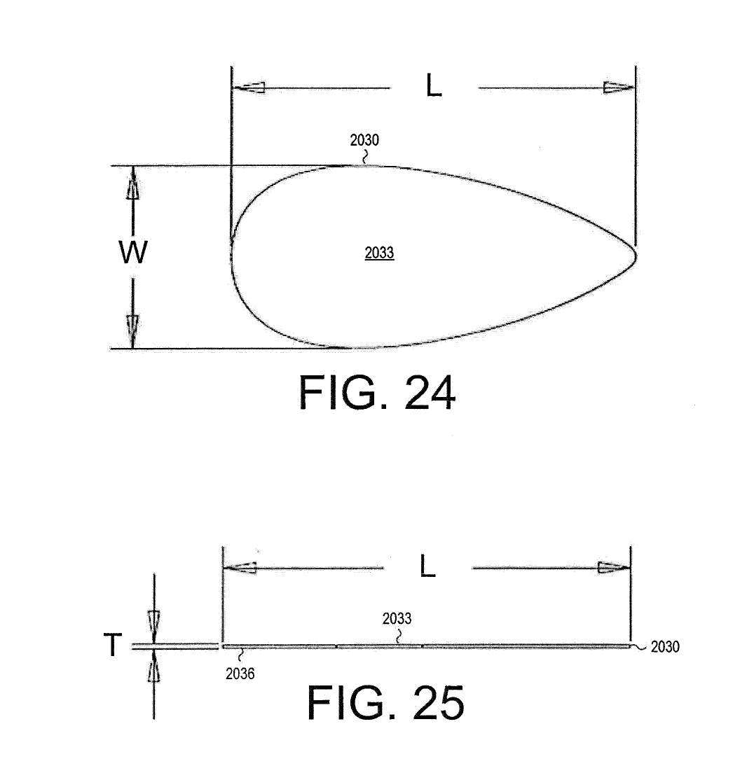

FIG. 24 is a top view of the gripping pad 2030 of FIG. 20, according to disclosed embodiments. As shown in FIG. 24, the gripping pad 2030 is formed to have a length L and a width W. In the embodiments disclosed in FIGS. 20-25, the gripping pad has a length L between 1 and 5 inches, and a width W between 0.5 and 2.5 inches.

FIG. 25 is a side view of the gripping pad 2030 of FIG. 20, according to disclosed embodiments. As shown in FIG. 25, the gripping pad 2030 has a thickness T that is small with respect to its length L and width W. In the embodiments disclosed in FIGS. 20-25, the gripping pad 2030 has thickness T between 20-100 mils. However, the thickness T of the gripping pad 2030 can be below 20 mils in some embodiments, and above 100 mils in other embodiments.

Although the above embodiments disclose a gripping pad 2030 used with a teardrop-shaped surface flow enhancement device 2000, any of the above aerodynamic shapes disclosed above could be used (i.e., as shown in FIGS. 1A-1E, 7A-7E, and 8A-8E) for the aerodynamic portion 2013.

Conclusion

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled. The various circuits described above can be implemented in discrete circuits or integrated circuits, as desired by implementation.

What is claimed is:

1. A surface flow enhancement device, comprising:
a first part having an aerodynamic portion and a fastening portion, the aerodynamic portion being configured to deflect moving air incident upon the aerodynamic portion;
a second part having a first side and a flat second side, the second part including
a securing element configured to secure the second part to the fastening portion of the first part, such that the first side faces toward the first part and the flat second side faces away from the first part, and
one or more attaching elements configured to attach the surface flow enhancement device to a surface of a vehicle; and
a gripping pad having an adhesive side that is attached to the flat second side of the second part, and a gripping side opposite to the adhesive side that is configured to inhibit movement of the surface flow enhancement device in a direction parallel to the surface of the vehicle when the surface flow enhancement device is attached to the surface of the vehicle.

2. The surface flow enhancement device, of claim 1, wherein
the gripping side of the gripping pad comprises at least one of: acrylic, rubber, a thermoplastic elastomer, polyvinyl chloride, polyester, vinyl, and polyurethane.

3. The surface flow enhancement device, of claim 1, wherein
a plurality of projections are formed on the gripping side to be perpendicular to the of the flat second side of the second part, and
a tip of each of the plurality of projections is configured to move in a direction parallel to the flat second side of the second part when force is applied to the tip in the direction parallel to the flat second side of the second part.

4. The surface flow enhancement device, of claim 1, wherein
the aerodynamic portion has a teardrop shape.

5. The surface flow enhancement device, of claim 4,
wherein the teardrop shape has a length between 1 and 5 inches, and
wherein the teardrop shape has a width between 0.5 and 2.5 inches.

6. The surface flow enhancement device, of claim 1, wherein
the aerodynamic portion has one of a fin shape and an oval shape with a front fin.

7. The surface flow enhancement device, of claim 1, wherein
the one or more attaching elements comprise one or more magnets.

8. The surface flow enhancement device, of claim 1, wherein
the one or more magnets are rare-earth magnets.

9. The surface flow enhancement device, of claim 1, wherein
the one or more attaching elements are further configured to detach the surface flow enhancement device from the surface of the vehicle without altering the surface of the vehicle.

10. The surface flow enhancement device, of claim 1, wherein
the gripping side of the gripping pad has an adhesive surface.

11. A surface flow enhancement device, comprising:
an aerodynamic surface having a teardrop shape;
one or more attaching elements configured to attach the surface flow enhancement device to a surface of a vehicle; and
a gripping surface configured to inhibit movement of the surface flow enhancement device in a direction parallel to the surface of the vehicle when the surface flow enhancement device is attached to the surface of the vehicle,
wherein the teardrop shape has a length between 1 and 5 inches, and
wherein the teardrop shape has a width between 0.5 and 2.5 inches.

12. The surface flow enhancement device, of claim 11,
wherein the aerodynamic surface comprises a first material, and
wherein the gripping surface comprises a second material softer than the first material.

13. The surface flow enhancement device, of claim 12, wherein
the second material comprises at least one of: acrylic, rubber, a thermoplastic elastomer, polyvinyl chloride, polyester, vinyl, and polyurethane.

14. The surface flow enhancement device, of claim 11, wherein
the gripping surface comprises a plurality of projections attached to a common planar base, and extending perpendicular to the common planar base, the plurality of projections all being substantially the same length, and
a tip of each of the plurality of projections is configured to move in a direction parallel to the common planar surface of the gripping pad when force is applied to the tip in the direction parallel to the common planar surface.

15. The surface flow enhancement device, of claim 11,
wherein the aerodynamic surface defines one or more concavities on an opposite side of the aerodynamic surface, and
the one or more attaching elements are formed in the one or more concavities.

16. The surface flow enhancement device, of claim 11,
wherein the one or more attaching elements comprise one or more magnets.

17. The surface flow enhancement device, of claim 11,
wherein the one or more magnets are rare-earth magnets.

18. The surface flow enhancement device, of claim 11, wherein
the one or more attaching elements are further configured to detach the surface flow enhancement device from the surface of the vehicle without altering the surface of the vehicle.

19. The surface flow enhancement device, of claim 11, wherein
the gripping side of the gripping surface has an adhesive surface.
